(19) United States
(12) Patent Application Publication
(10) Pub. No.: US 2021/0015057 A1
(43) Pub. Date: Jan. 21, 2021

(54) AEROPONIC BASKET SYSTEM AND METHOD OF USE

(71) Applicant: DOUGLASS INNOVATIONS, INC., SPICER, MN (US)

(72) Inventors: Brian L. Douglass, Spicer, MN (US); Carl R. Douglass, Spicer, MN (US)

(21) Appl. No.: 16/933,476

(22) Filed: Jul. 20, 2020

Related U.S. Application Data
(60) Provisional application No. 62/876,184, filed on Jul. 19, 2019.

(51) Int. Cl. A01G 31/02

(52) U.S. Cl. CPC A01G 31/02

(57) ABSTRACT

An aeroponic basket system and method of use in is disclosed herein. The aeroponic basket system for use in aeroponic plant growth includes a germination basket having a basket area including at least four sidewalls defining at least four openings, and a base portion, coupled to the at least four sidewalls, the base defining at least one opening, the germination basket comprising compostable material. The germination basket further having an interface lip extending around a periphery of the basket area opposite the base portion, the interface lip configured to interface with an aeroponic plant growth surface, the interface lip comprising a u-shaped channel that extends around a periphery of the basket area, the u-shaped channel oriented toward the base portion. The aeroponic basket system for use in aeroponic plant growth includes an organic germination media configured to be housed within the basket area.

### CROSS REFERENCES TO RELATED APPLICATIONS

The following application claims priority under 35 U.S.C. 119(e) to co-pending U.S. Provisional Patent Application Ser. No. 62/876,184 filed Jul. 19, 2019 entitled AEROPONIC BASKET SYSTEM AND METHOD OF USE. The above-identified provisional application is incorporated herein by reference in its entirety for all purpose.

### TECHNICAL FIELD

The present disclosure relates to an aeroponic basket system and method of use, and more particularly, an aeroponic basket system and method of use for growing plants, while preventing plant tipping and water escaping the aeroponic basket system.

### BACKGROUND

Aeroponic growing is a method of growing plants (e.g., any flora) suspended in three dimensional space with a specific air or mist environment. Typically, plants are grown in soil, or with hydroponics in water. Aeroponics allow for high density crops to be grown year-round in any climate. Aeroponics reduces the likely hood of disease and bacteria that is common in traditionally grown plants. This is accomplished by precisely controlling various factors, including the water source, the water input and/or the water output, light input, and nutrient content. Aeroponics further minimizes a quantity of water needed to provide for each individual plant, as compared to hydroponics and traditional farming.

Aeroponics require less space and typically uses less resources (e.g., water and added nutrients) than traditional growing methods. In addition to space savings, this method of growing often yields larger and healthier plants in less time than traditionally grown plants.

As illustrated in FIG. 1A, in typical aeroponic growing, plants 12 are grown in aeroponic vertical or horizontal surfaces 10 (e.g., a wall or table) that separates the two essential plant needs; sunlight and water/nutrients. The leafy portion 14 of the plant 12 has light space (A) to grow and collect UV light for photosynthesis while the roots 16 of the plant grow in growth space (B) and are anchored by media while suspended in the air. In non-organic aeroponics, plants 12 are grown with a media 18 (e.g., such as a rockwool media lightweight expanded clay aggregate, coconut fiber/coconut chips, and/or perlite or vermiculit) that locks the roots into the vertical or horizontal surface 10. (see FIGS. 1B-1D).

Organically growing aeroponic plants 12 has unique challenges as compared to non-organic aeroponics. Traditional media 18 is filled with chemicals that do not comply with organic growing. To overcome this challenge, organic media pods are often used instead of the traditional media. Organic pods are delicate, and do not provide sufficient support to the plant 12, (e.g. less support than the media 18). To produce organic food, the growing process typically utilizes a reusable basket 20 to support of the plant 12. (see FIGS. 1E-1F). These reusable baskets 20 require careful handling, and must be kept from contamination to help maintain organic certification. The design of the reusable basket 20 has a direct impact on production output volume and grow time.

### SUMMARY

One example embodiment of the present disclosure includes an aeroponic basket system for use in aeroponic plant growth that includes a germination basket having a basket area including at least four sidewalls defining at least four openings, and a base portion, coupled to the at least four sidewalls, the base defining at least one opening, the germination basket comprising compostable material. The germination basket further having an interface lip extending around a periphery of the basket area opposite the base portion, the interface lip configured to interface with an aeroponic plant growth surface, the interface lip comprising a u-shaped channel that extends around a periphery of the basket area, the u-shaped channel oriented toward the base portion. The aeroponic basket system for use in aeroponic plant growth includes an organic germination media configured to be housed within the basket area.

Another example embodiment of the present disclosure includes an aeroponic basket system for use in aeroponic plant growth comprising a germination basket comprising compostable material. The germination basket includes an upper portion and a lower portion, the lower portion having at least four sidewalls defining at least four openings. The at least four sidewalls forming a lower connecting wall, the lower connecting wall coupled to a base wall, the base wall defining at least one base opening. The upper portion includes an interface lip extending around a periphery of the basket area opposite the base wall, the interface lip is configured to interface with an aeroponic plant growth surface. The interface lip includes a u-shaped channel that extends around a periphery of the basket area, the u-shaped channel is oriented toward the base wall, the at least four sidewalls forming an upper connecting wall, the upper connecting wall coupling the interface lip to the at least four sidewalls.

Yet another example embodiment of the present disclosure includes an aeroponic basket system for use in aeroponic plant growth comprising a germination basket comprising a compostable material, the germination basket comprising a lower portion coupled to an upper portion, the lower portion defining a substantially cylindrical shape, the lower portion comprising a basket area. The basket area includes five sidewalls defining five openings, the five sidewalls combining into an upper connecting wall and a lower connecting wall, the lower connecting wall coupled to the upper connecting wall by the five sidewalls, a base wall coupled to the lower connecting wall, the base wall defining a central opening, the germination basket, and at least one water shield coupled to the upper connecting wall and adjacent sidewalls of the five sidewalls, wherein the water shield extends at least partially into at least one of the five openings. The upper portion is coupled to the lower portion by a coupling section supporting at least one retaining lip, the upper portion has a substantially rectangular shape. The upper portion includes an interface lip extending around a periphery of the basket area opposite the base wall. The interface lip is configured to interface with an aeroponic plant growth surface. The interface lip defines a u-shaped channel that extends around a periphery of the basket area, the u-shaped channel oriented toward the base wall. The basket system includes an organic germination media configured to be housed within the basket area.

### BRIEF DESCRIPTION OF THE DRAWINGS

The foregoing and other features and advantages of the present disclosure will become apparent to one skilled in the art to which the present invention relates upon consideration of the following description of the invention with reference to the accompanying drawings, wherein like reference numerals refer to like parts unless described otherwise throughout the drawings and in which:

FIG. 1A is a schematic view of a prior art aeroponic vertical or horizontal surface;

FIG. 1B is a perspective view of a prior art aeroponic media;

FIG. 1C is a front view of a prior art aeroponic media being housed in a prior art aeroponic vertical or horizontal surface;

FIG. 1D is a side perspective view of a prior art aeroponic media being housed in a prior art aeroponic vertical or horizontal surface;

FIG. 1E is a front perspective view of a prior art aeroponic reusable bucket;

FIG. 1F is a front view of illustrating standard plant root growth in a prior art aeroponic reusable bucket;

FIG. 2 is a front perspective view of a germination cup for use in an aeroponic basket system in accordance with one example embodiment of the present disclosure;

FIG. 3 is a bottom perspective view of FIG. 2;

FIG. 4 is a top view of FIG. 2;

FIG. 5 is a front perspective view of an organic growing media for use in a germination cup in an aeroponic basket system in accordance with one example embodiment of the present disclosure;

FIG. 6 is a front perspective view of an organic growing media housed within a germination cup for use in an aeroponic basket system in accordance with one example embodiment of the present disclosure;

FIG. 7 is a top perspective view of an organic growing media housed within a germination cup for use in an aeroponic basket system in accordance with one example embodiment of the present disclosure;

FIG. 8 is a front perspective view of an aeroponic basket system including an organic growing media housed within a germination cup installed in aeroponic vertical or horizontal surface in accordance with one example embodiment of the present disclosure;

FIG. 9 is a top view of FIG. 8;

FIG. 10 is a front perspective view of illustrating plant root growth in an aeroponic basket system including an organic growing media housed within a germination cup in accordance with one example embodiment of the present disclosure;

FIG. 11 is a front perspective view of a germination cup for use in an aeroponic basket system in accordance with one example embodiment of the present disclosure;

FIG. 12 is a bottom perspective view of FIG. 11;

FIG. 13 is a top view of FIG. 11;

FIG. 14 is a cross-section view taken along section line C-C of FIG. 13;

FIG. 15 is a magnified view of section E of FIG. 14;

FIG. 16 is a front elevation view of FIG. 11;

FIG. 17 is a magnified view of section D of FIG. 14; and

FIG. 18 is a front elevation view of a germination cup angled for use in an aeroponic basket system in accordance with one example embodiment of the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

Referring now to the figures generally wherein like numbered features shown therein refer to like elements throughout unless otherwise noted. The present disclosure relates to an aeroponic basket system and method of use, and more particularly, an aeroponic basket system and method of use for growing plants, while preventing plant tipping and water escaping the aeroponic basket system.

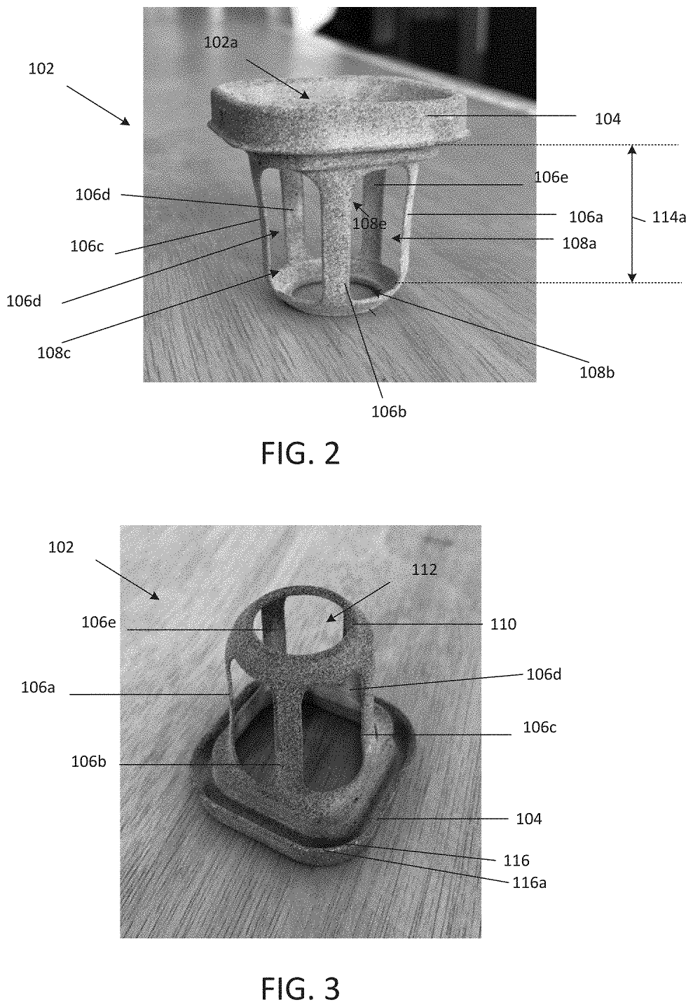

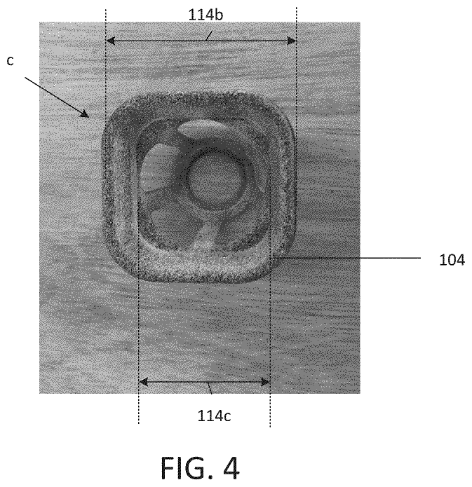

FIGS. 2-4 illustrate an example germination basket 102. The germination basket 102 includes an interface lip 104, and a basket area 102a defined by first, second, third, fourth, and fifth sidewalls 106a-106e, each sidewall defining first, second, third, fourth, and fifth growth openings 108a-108e, respectively. The basket area 102a of the germination basket 102 further includes a base wall 110 coupled to at least one of the first, second, third, fourth, and fifth sidewalls 106a-106e. The base wall 110 defines a base opening 112. The interface lip 104 extends around at least a portion of the periphery of the basket area 102a opposite the base wall 110. It would be appreciated by one have ordinary skill in the art that there could be greater or fewer than five sidewalls, and five growth openings, and greater than a single base opening.

The germination basket 102 comprises one or more compostable materials. In one example, the one or more compostable materials are biodegradable materials. In another example embodiment, the compostable material comprises at least one of cellulose, industrial molded pulp, PLA plastic, and/or Spanish moss. This is advantageous as the compostable material is inexpensive, allowing the germination basket to be a single use basket, which helps prevent contamination and eliminates labor involved in basket cleaning of the traditional reusable basket 20. Further, the compostable material is texturized to increase surface area that can retain water and nutrients, that can then be absorbed by the roots 16a of the plant 12. In one example embodiment, the texturized material comprises high surface energy features, such as found in cellulose and/or wood grain. In another example, such as responsive to the compostable material comprising PLA plastic, texture is added to the surface of the compostable material (e.g., during molding, by abrasions, etc.). This increased surface area generates a longer feed time (e.g., time when the roots 16a have access to the nutrients) without actively feeding the plant 12, this also increases time between water cycles, thus reducing overall energy requirements for growth of plants in the aeroponic vertical or horizontal surfaces 10.

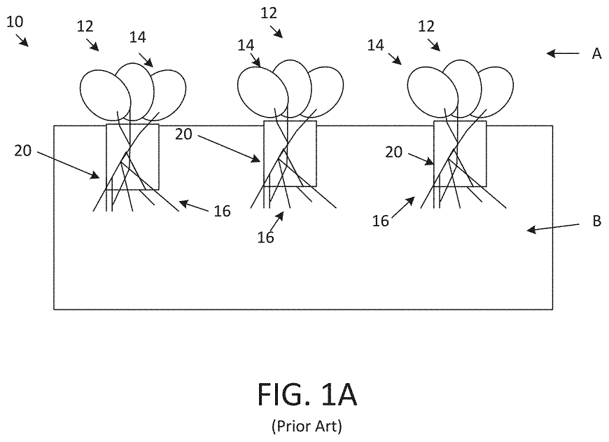

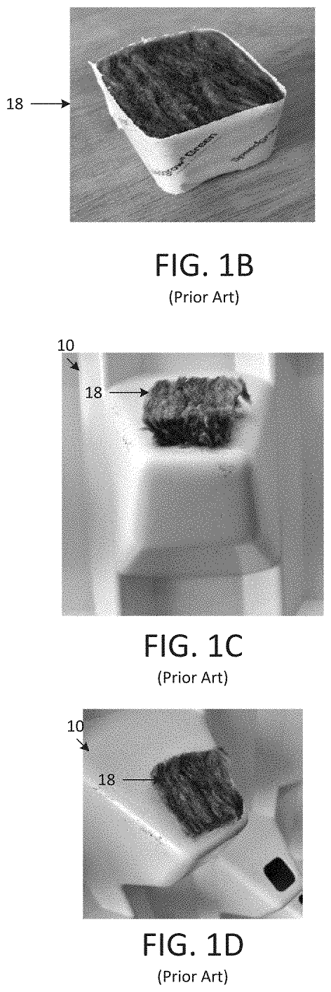

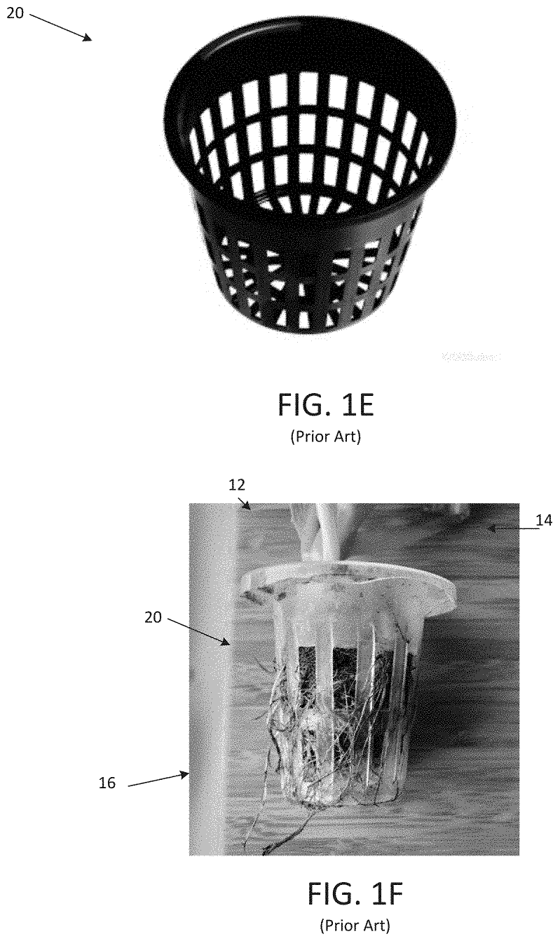

The first, second, third, fourth, and fifth growth openings 108a-108e as well as the base opening 112 promotes early stage growth, increased air penetration, improved water penetration, and/or increases yield as compared to the traditional basket 20. For example, the root growth 16a shown in FIG. 10 is denser and has more surface area open to the aeroponic environment in growth space (B) than the traditional basket 20 illustrated in FIG. 1F.

The first, second, third, fourth, and fifth sidewalls 106a-106e have a sidewall length 114a and the interface lip 104 has a lip width 114b. The sidewall length 114a to the lip width 114b has a stability ratio is between 2:1 to 10:1. The stability ratio prevents tall plants from tipping, while the lip width 114b is configured to securely fit within the aeroponic vertical or horizontal surfaces 10. The germination basket 102 has a basket width 114c, measured at a top portion of the germination basket. The basket width 114c to the lip width 114b has a security ratio is between 1:1 to 7:1. The security ratio secures/locks the interface lip 104 relative to the aeroponic vertical or horizontal surfaces 10, as the interface lip has a width relationship with the germination basket 102 that allows the interface lip to interact with a top surface of the aeroponic vertical or horizontal surfaces to stabilize the germination basket, regardless of a size or weight of the leafy portion 14 of the plant 16.

The interface lip 104 includes a u-shaped channel 116, wherein the channel interacts with a top/outer surface of the aeroponic vertical or horizontal surface 10 to prevent water from evaporating out of the system, as water vapor is caught and retained in the channel. The channel 116 is oriented to face the base wall 110, such that the germination basket 102 rests in an outermost edge 116a of the channel when in use in the aeroponic vertical or horizontal surfaces 10. Further, the interface lip 104 provides an easy gripping point to remove the germination basket 102 from the aeroponic vertical or horizontal surfaces 10, reducing harvest time. Additionally, the interface lip 104, and the u-shaped channel 116 prevent contamination, as the interface lip creates a barrier to entry into the growth space (B).

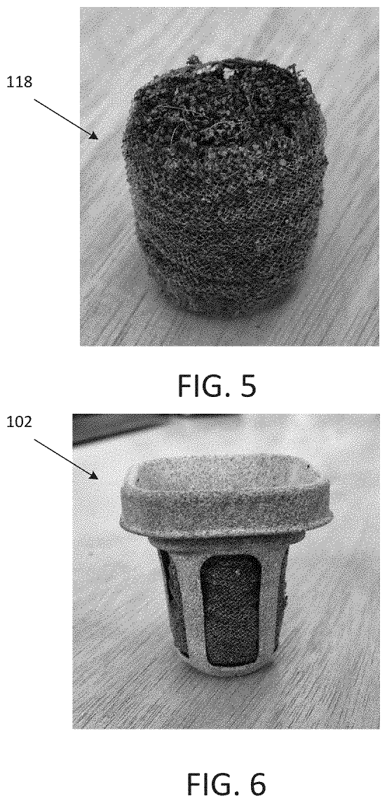

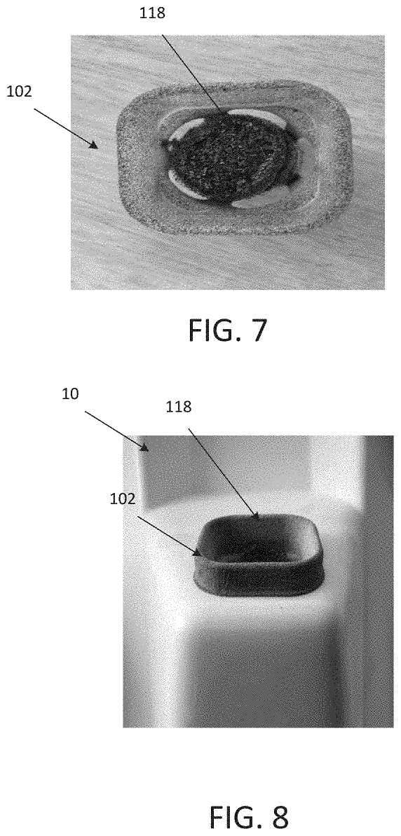

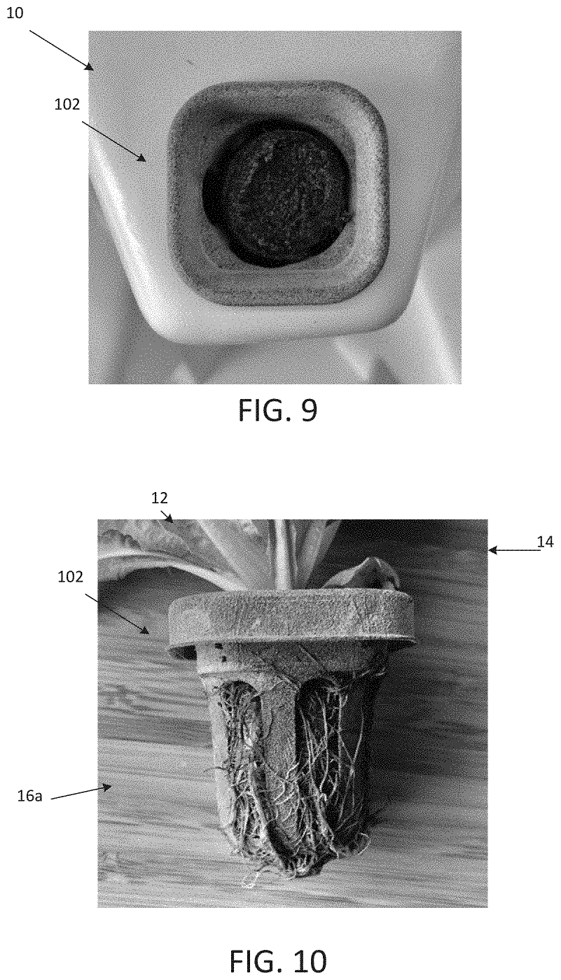

In the illustrated example embodiment of FIGS. 5-7, an organic growing media 118 comprising organic materials and/or a biodegradable mesh, is housed within the basket area 102a. The germination basket 102 housing the organic growing media 118 is fitted within the aeroponic vertical or horizontal surfaces 10. (see FIGS. 8-9). Within the aeroponic vertical or horizontal surfaces 10 the roots 16a are exposed to water and nutrients in the growth space (B), while the leafy portion 12 is exposed to light, as needed in the light space (A).

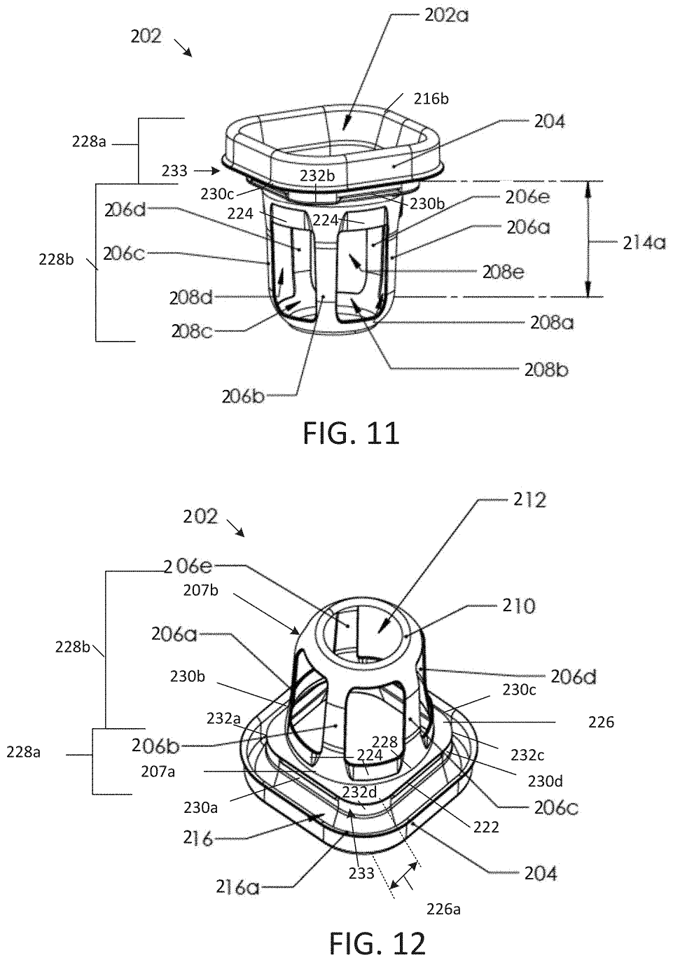

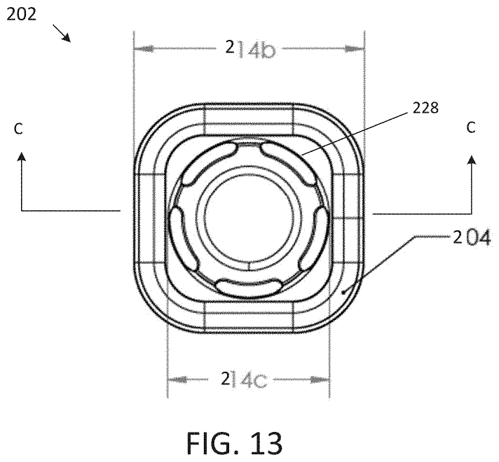

Another example embodiment of the germination basket 202 is illustrated in FIGS. 11-18. Features of the germination basket 202 illustrated in FIGS. 11-18 that are similar to the features of the germination basket 102 illustrated in FIGS. 1-10 will be identified by like numerals increased by a factor of one-hundred, unless stated otherwise. FIGS. 11-18 illustrate the example germination basket 202. The germination basket 202 includes an interface lip 204, and a basket area 202a comprising a plurality of sidewalls 206 defining one or more growth openings 208. In one example embodiment, the germination basket 202 includes first, second, third, fourth, and fifth sidewalls 206a-206e, each sidewall defining first, second, third, fourth, and fifth growth openings 208a-208e, respectively. In this example embodiment, the growth openings 208 defined by the sidewalls 206 are transverse to a central axis CA of the basket area 202a. In one example embodiment, the sidewalls 206 are parallel to or extend along a substantially common direction to the central axis CA. The basket area 202a of the germination basket 202 further includes a base wall 210 coupled to at least one of the first, second, third, fourth, and fifth sidewalls 206a-206e. The base wall 210 defines a base opening 212. The base wall 210 extends at least one of transverse to or perpendicular to the central axis CA. In one example embodiment, the central axis CA goes through the base opening 212. In another example embodiment, the central axis CA is centrally located relative to the base opening 212.

In one example embodiment, the interface lip 204 extends around at least a portion of the periphery of the basket area 202a opposite the base wall 210. It would be appreciated by one have ordinary skill in the art that there could be greater or fewer than five sidewalls, and five growth openings, and greater than a single base opening. In the illustrated example embodiment, the interface lip 204 is substantially square, however it would be apricated by one of ordinary skill in the art that rectangular, polygonal, ovular and/or circular shapes are contemplated.

As illustrated in the example embodiments of FIGS. 11-12, and 16, the germination basket 202 includes an upper portion 228a and a lower portion 228b, wherein the upper portion includes the interface lip 204, and a support base 226, and the lower portion includes the sidewalls 206 and the base wall 210. The upper portion 228a is coupled to the lower portion 228b at an intersection 228. In the illustrated example embodiment, the lower portion 228b defines a substantially cylindrical shape wherein the upper portion 228a defines a substantially square or rectangular shape. The intersection 228 couples the substantially cylindrical shape of the lower portion 228b to the substantially square or rectangular shape of the upper portion 228a, such that the upper portion defines a substantially circular space.

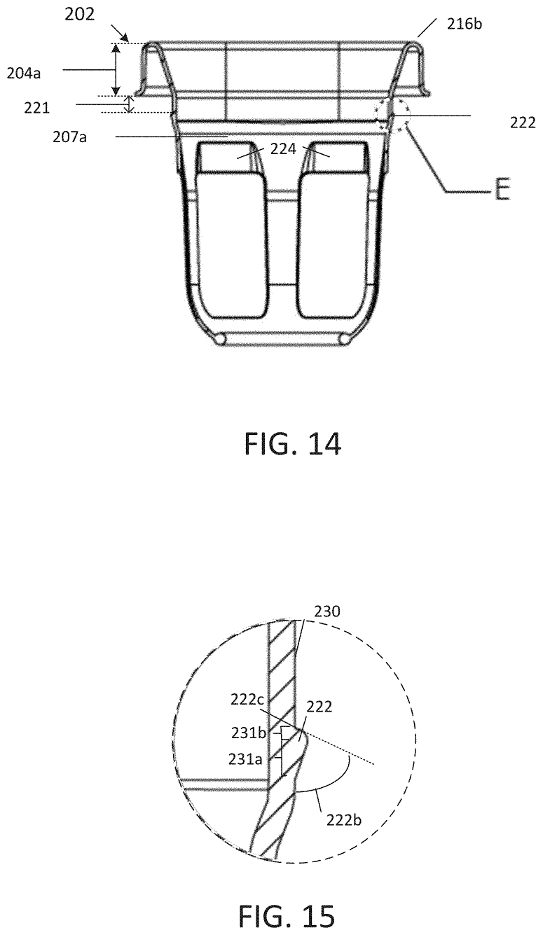

In the illustrated example embodiment of FIGS. 11-13, the support base 226 is substantially planner and couples the interface lip 204 to the sidewalls 206. In one example embodiment, the first, second, third, fourth, and fifth sidewalls 206a-206e combine into a connecting wall 207a as the sidewalls extend toward the support base 226, wherein the connecting wall 207a is coupled to the support base 226 via the intersection 228. In the illustrated example embodiment of FIGS. 11 and 14, the connecting wall 207a extends around the entirety of the cylindrical body of the lower portion 228a and is coupled to the support base 226. In another example embodiment, the sidewalls 206 are transverse to the support base 226.

In the illustrated embodiment of FIGS. 12-16, the first, second, third, fourth, and fifth sidewalls 206a-206e combine into a second connecting wall 207b as the sidewalls extend away from connecting wall 207a and connect to the base wall 210. The second connecting wall 207b extends around the entirety of the cylindrical body of the lower portion 228a and is coupled to the base wall 210. In one example embodiment, the second connecting wall 207b comprises an arced surface that couples the sidewalls 206 to the base wall 210. In another example embodiment, the second connecting wall 207b comprises a corner that couples the sidewalls 206 to the base wall 210.

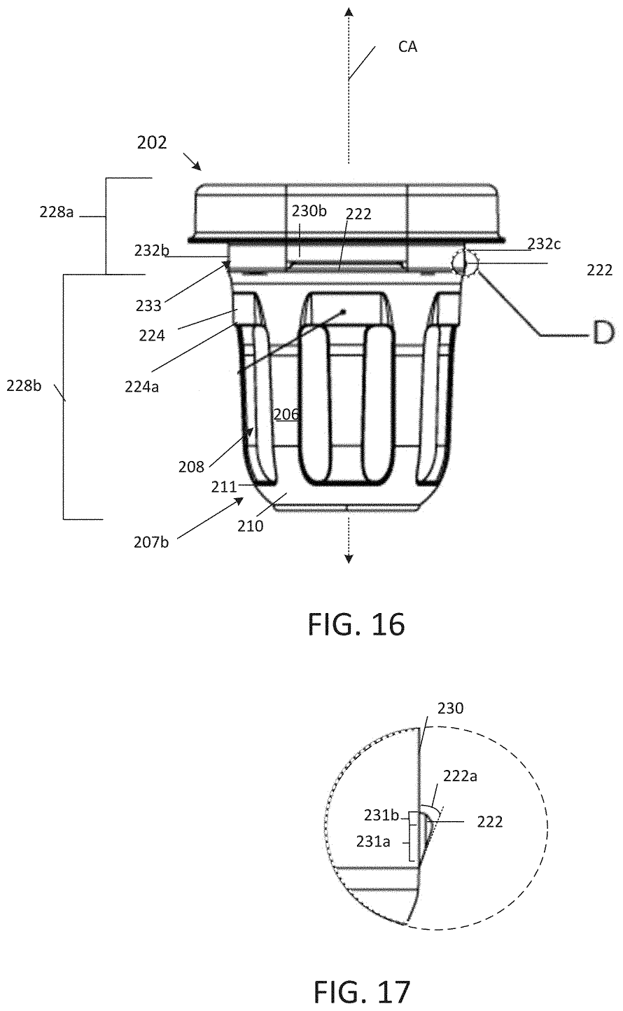

As illustrated in FIGS. 11-12, 14, 16 and 18, the connecting wall 207a supports one or more water shields 224 positioned to define a portion of the one or more growth openings 208. The one or more water shields 224 are coupled to respective sidewalls 206 and the connecting wall 207a. In one example embodiment, the one or more water shields 224 extend away from the interface lip 204 toward the base wall 210. As illustrated in the example embodiment of FIG. 16, a water shield 224 extends away from the central axis CA, wherein a water edge 224a of the water shield (e.g. an edge extending farthest from the connecting wall 207a) protrudes away from the central axis and extends outwardly a greater distance then a portion 211 of the second connecting wall 207b that defines the respective growth opening 208. In one example embodiment, the one or more water shields 224 are substantially parallel to the central axis CA.

In one example embodiment, the interface lip 204 includes a u-shaped channel 216. The channel 216 is oriented to face the base wall 210, such that the germination basket 202 rests in an outermost edge 216a of the channel when in use in the aeroponic vertical or horizontal surfaces 10. In one example embodiment, a lip length 204a (see FIG. 14) measured from a top of the u shaped channel 226 to the edge 216a is less than or the same as a support distance 226a (see FIG. 12) measured from a bottom planar surface of the support surface 226 to a top 216b of the u-shaped channel. In another example embodiment, the support surface 226 resides on a same plane as the edge 216a of the u-shaped channel 216.

In the illustrated embodiment of FIG. 12, the support surface 226 is coupled to the interface lip 204 by a coupling section 233. Wherein the coupling section 233 is configured to fit within an opening in the aeroponic vertical or horizontal surfaces 10 such the edge 216a is in contact with the aeroponic vertical or horizontal surfaces. In the illustrated example embodiment of FIG. 12, the coupling section 233 has a substantially same shape as the interface lip 204. In one example embodiment the coupling section 233 is coupled directly to the interface lip 204 and the support surface 226 is absent.

For example, in the illustrated embodiment of FIGS. 11-12, 14-17, the coupling section 233 supports at least one retaining lip 222. In one example embodiment, the coupling section 233 defines one or more faces 230a-230d coupled together respectively by one or more corners 232. In another example embodiment, four faces 230a, 230b, 230c, 230d are coupled to each other respectively by four corners 232a, 232b, 232c, 232d. Each face 230 supports one retaining lip 222. As illustrated in FIGS. 15 and 17, a first portion 231a of the retaining lip extends away from a surface of the substantially planer face 230a-230d at a first angle 222a and a second lip portion 231b extends back toward the substantially planer face at a second angle 222b. In one example embodiment, the first angle 222a is between 10° and 50°. In another example embodiment, the second angle 222b is between 55° and 89°. In one example embodiment, a lip edge distance 221 between the edge of the interface lip 216a and a top portion 222c of the retaining lip 222 is configured to be the same as a thickness of a material defining the aeroponic growing surface opening.

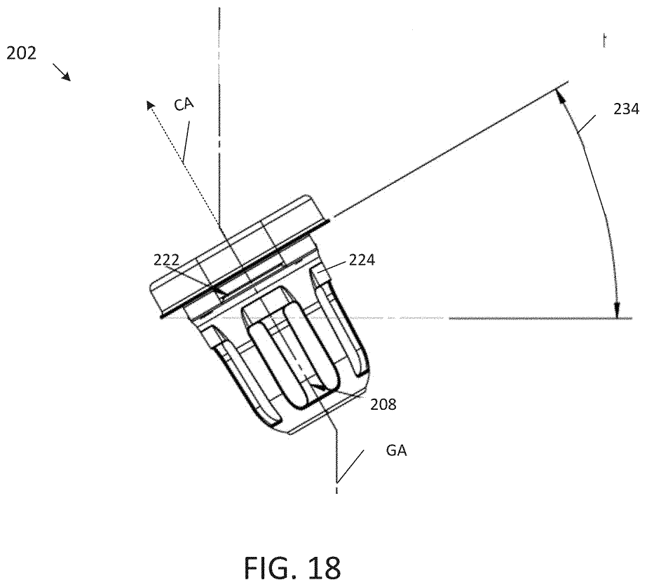

In the example embodiment of FIG. 18, the germination cup 202 is positioned at a growth angle 234 (e.g., as when the germination cup is in place in the aeroponic vertical or horizontal surfaces 10). In one example embodiment, the growth angle 234 is between 20° and 40°. In another example embodiment, the growth angle 234 is 30°. The positioning of the germination cup 202 along the growth angle 234 defines a gravity axis GA, wherein a root system will extend along the gravity axis when in use. The germination cup 202 formed by molding, extruding, weaving, and/or compression formation.

Advantageously, the germination basket 102, 202 comprises one or more compostable materials. This is advantageous as the compostable material is inexpensive, allowing the germination basket to be a single use basket, which helps prevent contamination and eliminates labor involved in basket cleaning of the traditional reusable basket 20. Further, the compostable material is texturized to increase surface area that can retain water and nutrients, that can then be absorbed by the roots 16a of the plant 12. This increased surface area generates a longer feed time (e.g., time when the roots 16a have access to the nutrients) without actively feeding the plant 12, this also increases time between water cycles, thus reducing overall energy requirements for growth of plants in the aeroponic vertical or horizontal surfaces 10.

Further, the first, second, third, fourth, and fifth growth openings 208a-208e as well as the base opening 212 promotes early stage growth, increased air penetration, improved water penetration, and/or increases yield as compared to the traditional basket 20. The water shields 224 retain water to further improve water penetration, while the interface lip 204 in conjunction with the retaining lip 222 help retain water from being lost through evaporation.

In the foregoing specification, specific embodiments have been described. However, one of ordinary skill in the art appreciates that various modifications and changes can be made without departing from the scope of the disclosure as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The disclosure is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art. In one non-limiting embodiment the terms are defined to be within for example 10%, in another possible embodiment within 5%, in another possible embodiment within 1%, and in another possible embodiment within 0.5%. The term “coupled” as used herein is defined as connected or in contact either temporarily or permanently, although not necessarily directly and not necessarily mechanically. A device or structure that is “configured” in a certain way is configured in at least that way, but may also be configured in ways that are not listed.

To the extent that the materials for any of the foregoing embodiments or components thereof are not specified, it is to be appreciated that suitable materials would be known by one of ordinary skill in the art for the intended purposes.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. An aeroponic basket system for use in aeroponic plant growth comprising:
a) a germination basket comprising a textured material, the germination basket comprising:
i) a lower portion comprising a basket area, the basket area comprising:
1) at least four sidewalls defining at least four openings; and
2) a base wall coupled to the at least four sidewalls, the base wall defining at least one opening; and
ii) an upper portion coupled to the lower portion, the upper portion comprising an interface lip extending around a periphery of the basket area opposite the base wall, the interface lip configured to interface with an aeroponic plant growth surface, the interface lip comprising a u-shaped channel that extends around a periphery of the basket area, the u-shaped channel oriented toward the base wall; and
b) an organic germination media configured to be housed within the basket area.

2. The aeroponic basket system of claim 1, comprising a least one water shield coupled to a sidewall of the at least four sidewalls, the water shield extending away from the interface lip.

3. The aeroponic basket system of claim 1, wherein the at least four sidewalls combine into an upper connecting wall, the upper connecting wall coupling the at least four sidewalls to the upper portion.

4. The aeroponic basket system of claim 3, wherein the lower portion defines a substantially cylindrical body.

5. The aeroponic basket system of claim 4, wherein the upper connecting wall extends around an entirety of the substantially cylindrical body of the lower portion.

6. The aeroponic basket system of claim 5, wherein the at least four sidewalls combine into a lower connecting wall opposite the upper connecting wall, the lower connecting wall coupling the at least four sidewalls to the base wall, the lower connecting wall extending around the entirety of the substantially cylindrical body of the lower portion.

7. The aeroponic basket system of claim 1, wherein the interface lip comprises a substantially rectangular shape.

8. The aeroponic basket system of claim 7, wherein the interface lip is coupled to the lower portion by a coupling section, the coupling section comprising one or more planar surfaces.

9. The aeroponic basket system of claim 8, wherein one or more retaining lips extend outwardly from the one or more planar surfaces of the coupling section.

10. The aeroponic basket system of claim 9, wherein the coupling section comprise a substantially rectangular shape and is configured to fit within an aeroponic growing surface opening, such that the one or more retaining lips interact with the aeroponic growing surface opening.

11. The aeroponic basket system of claim 10, wherein each retaining lip of the one or more retaining lips has a first portion nearest the base wall and a second portion nearest the interface lip, the first portion extending away from the planar surface at a first angle between 10° and 50°.

12. The aeroponic basket system of claim 10, wherein each retaining lip of the one or more retaining lips has a first portion nearest the base wall and a second portion nearest the interface lip, the second portion extending away from the planar surface at a second angle between 55° and 89°.

13. The aeroponic basket system of claim 9, wherein a distance between each retaining lip of the one or more retaining lips and an edge of the interface lip is a same as a thickness of a material defining the aeroponic growing surface opening.

14. The aeroponic basket system of claim 1, wherein the germination basket comprises compostable material.

15. The aeroponic basket system of claim 1, wherein the germination basket comprises five sidewalls that define five openings and the base wall defines a central opening.

16. An aeroponic basket system for use in aeroponic plant growth comprising:
a germination basket comprising compostable material, the germination basket comprising an upper portion and a lower portion, the lower portion comprising at least four sidewalls defining at least four openings, the at least four sidewalls forming a lower connecting wall, the lower connecting wall coupled to a base wall, the base wall defining at least one base opening; and
the upper portion comprising an interface lip extending around a periphery of the basket area opposite the base wall, the interface lip configured to interface with an aeroponic plant growth surface, the interface lip comprising a u-shaped channel that extends around a periphery of the basket area, the u-shaped channel oriented toward the base wall, the at least four sidewalls forming an upper connecting wall, the upper connecting wall coupling the interface lip to the at least four sidewalls.

17. The aeroponic basket system of claim 16, wherein the interface lip is coupled to the lower portion by a coupling section, wherein one or more retaining lips extend outwardly from one or more planar surfaces of the coupling section.

18. The aeroponic basket system of claim 17, wherein each retaining lip of the one or more retaining lips has a first portion nearest the base wall and a second portion nearest the interface lip, the first portion extending away from the planar surface at a first angle between 10° and 50°, the second portion extending away from the planar surface at a second angle between 55° and 89°.

19. The aeroponic basket system of claim 16, wherein the lower connecting wall is opposite the upper connecting wall across the at least four sidewalls, the upper and lower connecting walls extending around the entirety of a cylindrical body of the lower portion, further wherein the interface lip comprises a substantially rectangular shape.

20. An aeroponic basket system for use in aeroponic plant growth comprising:
a) a germination basket comprising a compostable material, the germination basket comprising a lower portion coupled to an upper portion, the lower portion defining a substantially cylindrical shape, the lower portion comprising a basket area, the basket area comprising:
i) five sidewalls defining five openings, the five sidewalls combining into an upper connecting wall and a lower connecting wall, the lower connecting wall coupled to the upper connecting wall by the five sidewalls;
ii) a base wall coupled to the lower connecting wall, the base wall defining a central opening, the germination basket; and
iii) at least one water shield coupled to the upper connecting wall and adjacent sidewalls of the five sidewalls, wherein the water shield extends at least partially into at least one of the five openings; and
b) the upper portion coupled to the lower portion by a coupling section supporting at least one retaining lip, the upper portion comprising a substantially rectangular shape, the upper portion comprising an interface lip extending around a periphery of the basket area opposite the base wall, the interface lip configured to interface with an aeroponic plant growth surface, the interface lip comprising a u-shaped channel that extends around a periphery of the basket area, the u-shaped channel oriented toward the base wall; and
c) an organic germination media configured to be housed within the basket area.
